(19) United States
(12) Patent Application Publication
(10) Pub. No.: US 2026/0188769 A1
(43) Pub. Date: Jul. 2, 2026

(54) SYSTEMS AND METHODS FOR REDOX MEDIATED PRE-LITHIATION

(71) Applicant: A123 Systems LLC, Novi, MI (US)

(72) Inventors: William Smith, Cambridge, MA (US); Paul Joseph Gionet, Billerica, MA (US); Giancarlo Cincotta, Somerville, MA (US)

(21) Appl. No.: 19/431,639

(22) Filed: Dec. 23, 2025

Related U.S. Application Data
(60) Provisional application No. 63/739,450, filed on Dec. 27, 2024.

(51) Int. Cl. H01M 10/44; H01M 4/02; H01M 4/38; H01M 10/0525

(52) U.S. Cl. CPC H01M 10/446; H01M 4/382; H01M 10/0525; H01M 2004/028

(57) ABSTRACT

Methods and systems are provided for redox mediated pre-lithiation of a lithium battery. An uncharged lithium ion battery includes a cathode and an electrolyte. The cathode includes a cathode active material and cathode pre-lithiation material and the electrolyte includes a redox mediator having a redox potential higher than a redox potential of the cathode pre-lithiation material and outside an operating voltage window of the cathode active material.

### CROSS REFERENCE TO RELATED APPLICATION

The present application claims priority to U.S. Provisional Application No. 63/739,450 entitled SYSTEMS AND METHODS FOR REDOX MEDIATED PRE-LITHIATION filed Dec. 27, 2024. The entire content of the above application is hereby incorporated by reference for all purposes.

### FIELD

The present description relates generally to systems and methods for pre-lithiation in lithium ion batteries using a redox mediator.

### BACKGROUND AND SUMMARY

Cathode pre-lithiation additives such as Li₂O₂, Li₂CO₃, Li₂C₂O₄, Li₂O, Li₂O/metal, LiF/metal, among others are included in cathodes of lithium ion batteries to improve charge capacity and capacity retention by providing a source of additional lithium ions. The cathode pre-lithiation additives decompose electrochemically to release lithium ions. For some cathode pre-lithiation additives, the voltage demanded for decomposition is large enough to degrade other components of the lithium ion battery. Conventionally, the demanded voltage is lowered by including a solid state decomposition catalyst such as Co₃O₄ or other cathode active materials in the cathode. However, the effectiveness of the catalyst relies on sufficient solid-solid contact between the catalyst and additives, demanding effective milling and mixing. Even still, solid-solid contact may not be maintained when a mixed cathode slurry is cast on a current collector, thereby demanding a separate coating step for the cathode pre-lithiation additive and catalyst during manufacturing. Further, the solid state decomposition catalysts may not be chemically and/or electrochemically stable with other cell components, such as electrolyte. Additionally, catalysts that use metals such as cobalt may significantly increase a cost of raw materials used in the battery.

Inventors herein have identified the above problems and have determined solutions to at least partially solve the above problems. In one example, an uncharged lithium ion battery, comprising a cathode including a cathode active material and cathode pre-lithiation material, wherein the cathode has not been charged; and an electrolyte including a redox mediator, wherein the electrolyte is in fluid contact with the cathode and wherein a redox potential of the redox mediator is higher than a redox potential of the cathode pre-lithiation material and the redox potential of the redox mediator is outside an operating voltage window of the cathode active material. In this way, when charged, the redox mediator may facilitate decomposition of the pre-lithiation material. The redox mediator included in the electrolyte may have increased contact with the cathode pre-lithiation material when compared to a solid state catalyst included in the cathode. Further, a redox potential of the redox mediator outside the operating voltage window of the cathode active material may help prevent unwanted side reactions which may otherwise occur due the presence of the redox mediator.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 illustrates pre-lithiation of a lithium ion battery cathode using an electrolyte including a redox mediator.

FIG. 2 shows a flowchart of an example of a method for constructing and pre-lithiating the lithium ion battery of FIG. 1.

FIG. 3 shows a half cell potential as a function of percent theoretical capacity during pre-lithiation using the redox mediator and different cathode pre-lithiation materials.

FIG. 4 shows X-ray diffractograms of the cathode material pre-lithiated in FIG. 3 before and after pre-lithiation using the redox mediator.

FIG. 5 shows graphs of voltage as a function of specific capacity during first charge and discharge for a control half cell and a half cell including Li₂O₂, with and without the redox mediator.

FIG. 6 show graphs of voltage as a function of specific capacity for first charge and discharge for half cells including Li₂CO₃ and Li₂C₂O₄, with and without the redox mediator.

FIG. 7 shows graphs of voltage as a function of specific capacity for first charge and discharge of a control coin cell battery with and without the redox mediator.

FIG. 8 shows graphs of cycling stability of the control coin cell batteries of FIG. 7.

FIG. 9 shows graphs of voltage as a function of specific capacity for first charge and discharge and of cycling stability for a coin cell including Li₂O₂ and the redox mediator.

FIG. 10 shows graphs of voltage as a function of specific capacity for first charge and discharge and of cycling stability for a coin cell including Li₂CO₃ and the redox mediator.

FIG. 11 shows graphs of voltage as a function of specific capacity for first charge and discharge and of cycling stability for a coin cell including Li₂C₂O₄ and the redox mediator.

FIG. 12 shows graphs comparing voltage as a function of specific capacity for first charge and discharge of coin cell batteries with two different cathode pre-lithiation constructions.

FIG. 13 shows graphs comparing voltage as a function of specific capacity for first charge and discharge of control and pre-lithiated coin cells including different combinations of concentrations of the redox mediator and pre-lithiation charge rates.

FIG. 14 shows graphs comparing voltage as a function of specific capacity for first charge and discharge of coin cell batteries and single layer pouch (SLP) cell batteries including cathode pre-lithiation material and the redox mediator.

FIG. 15 shows graphs comparing pre-lithiation of SLP cell batteries at different pre-lithiation rates.

FIG. 16 shows a graph of voltage as a function of specific capacity for first charge and discharge of SLP cell batteries including different redox mediator concentrations and at different pre-lithiation rates.

### DETAILED DESCRIPTION

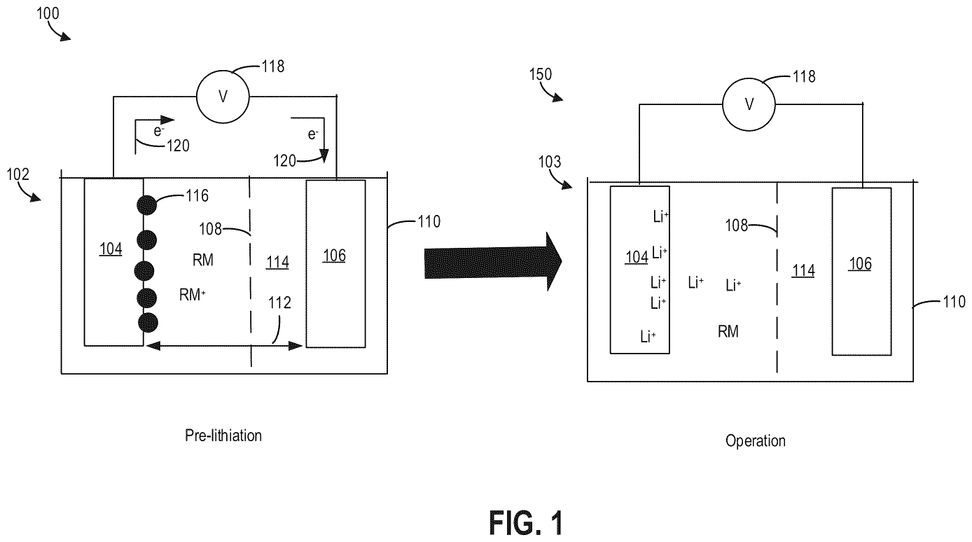

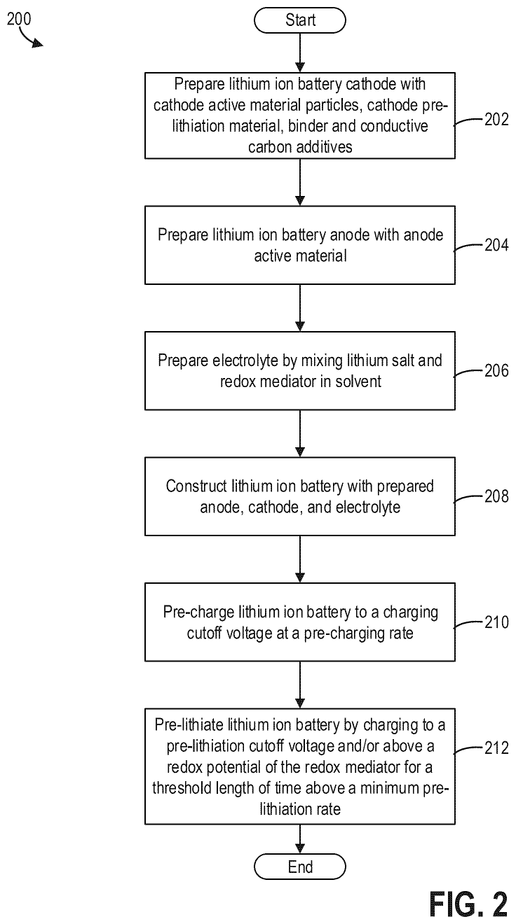

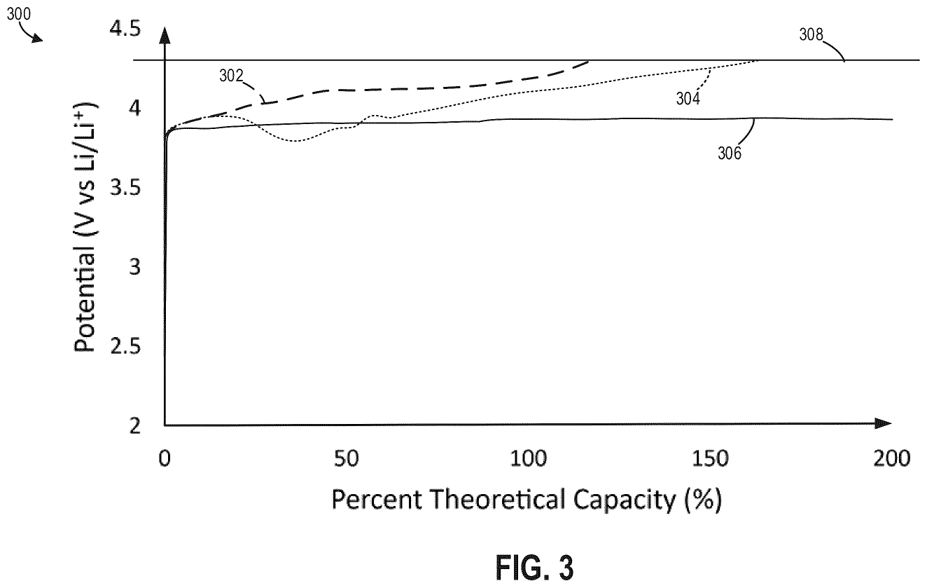

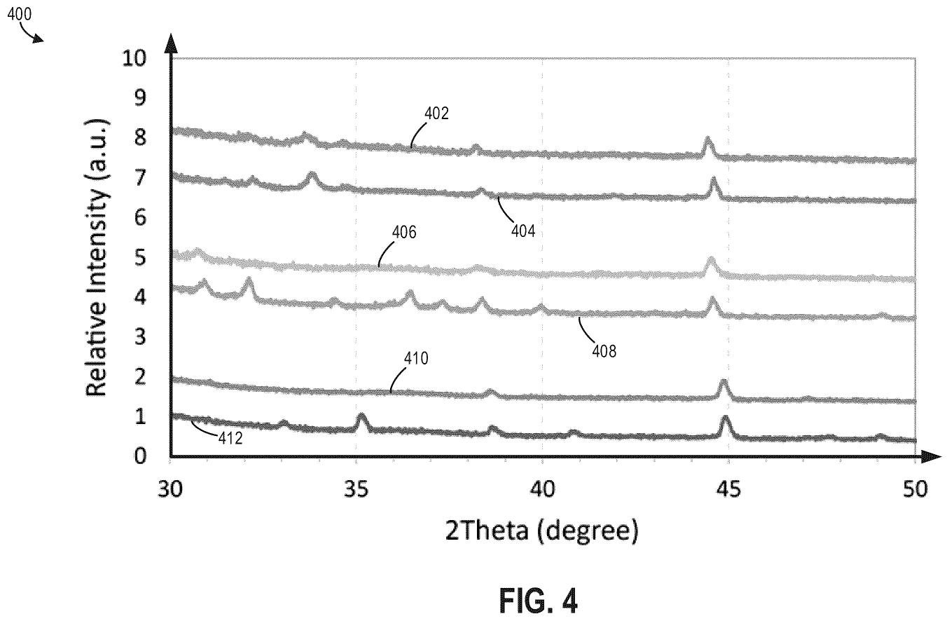

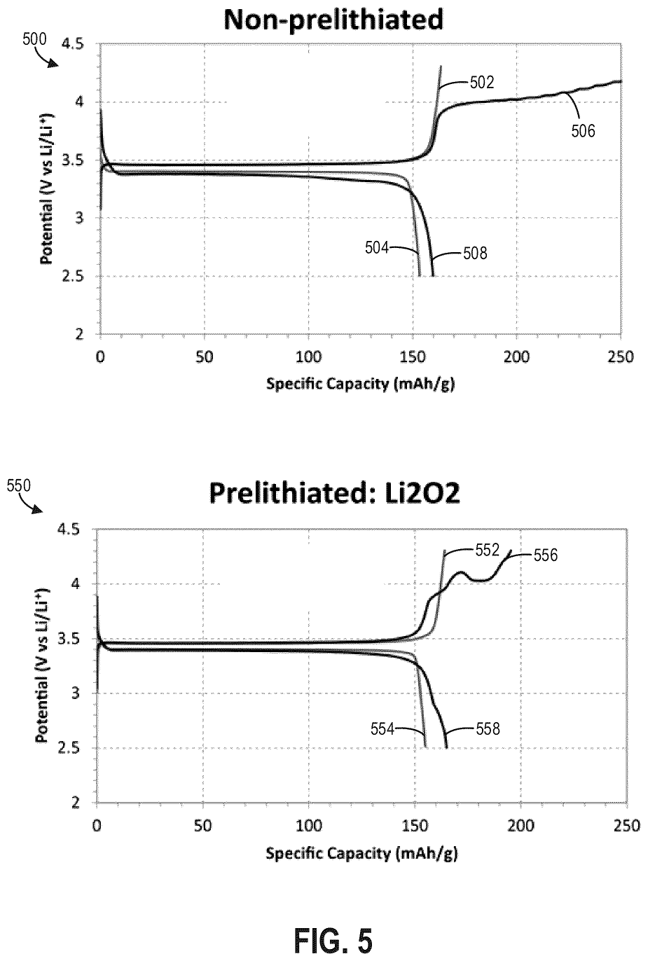

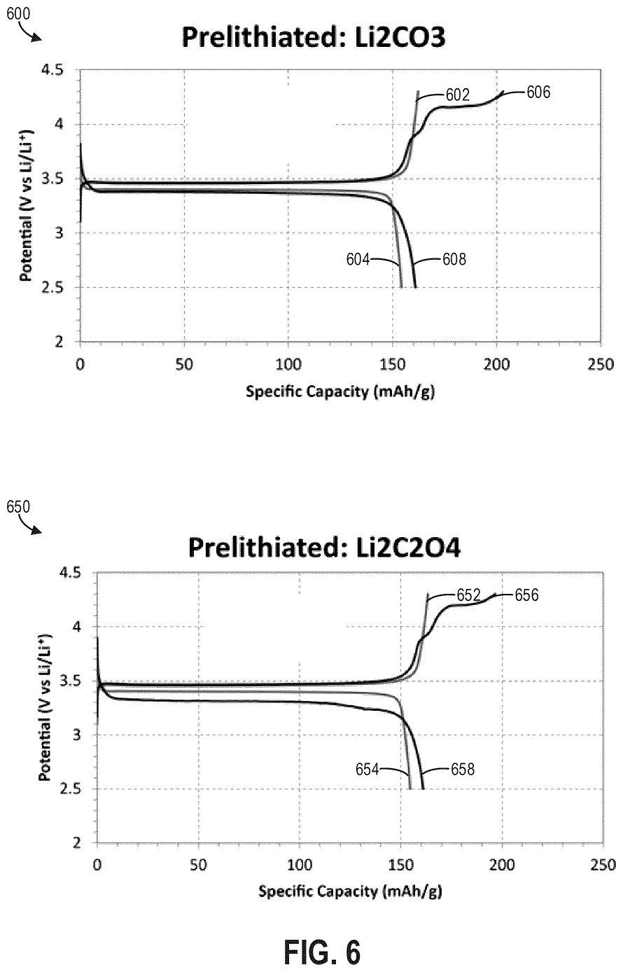

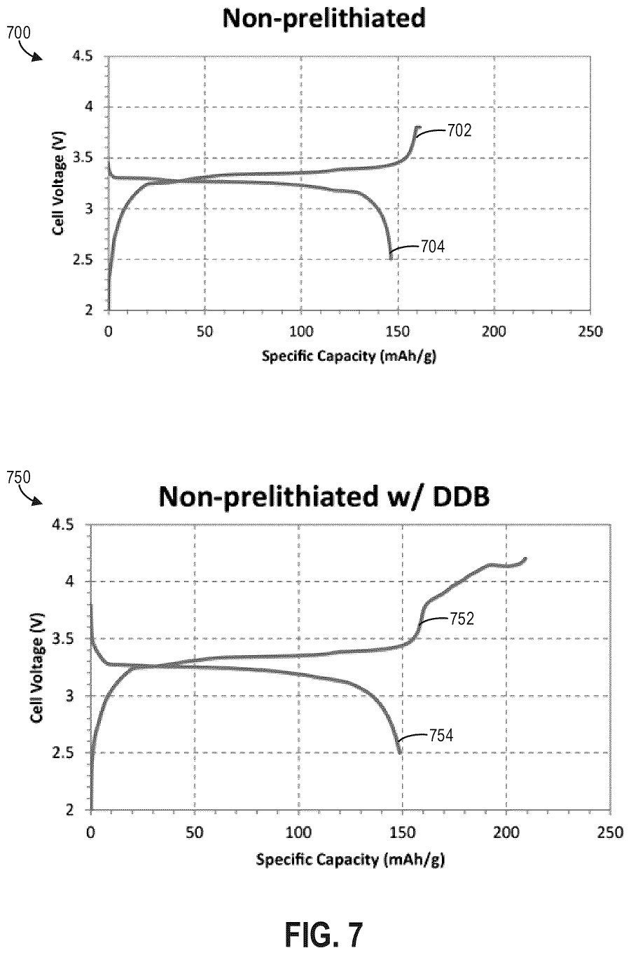

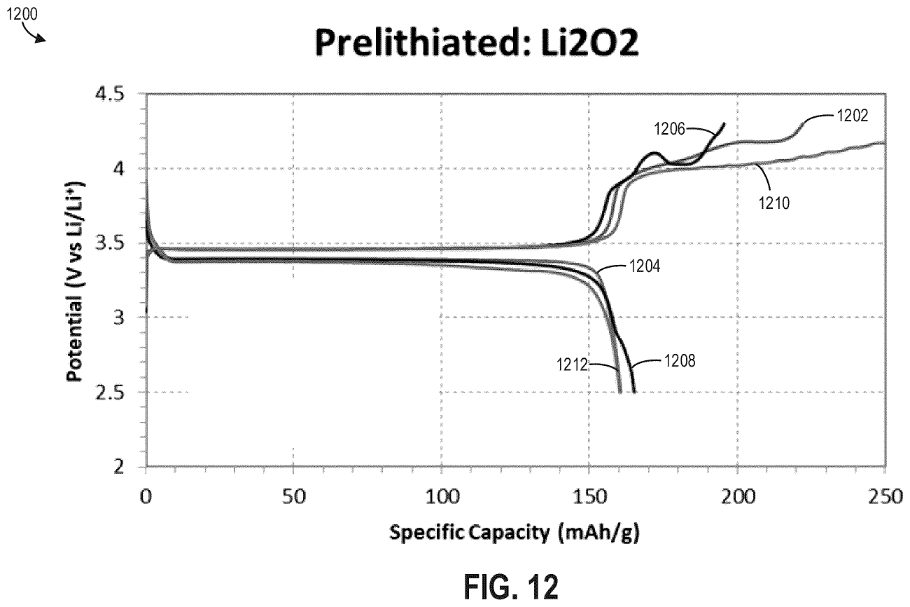

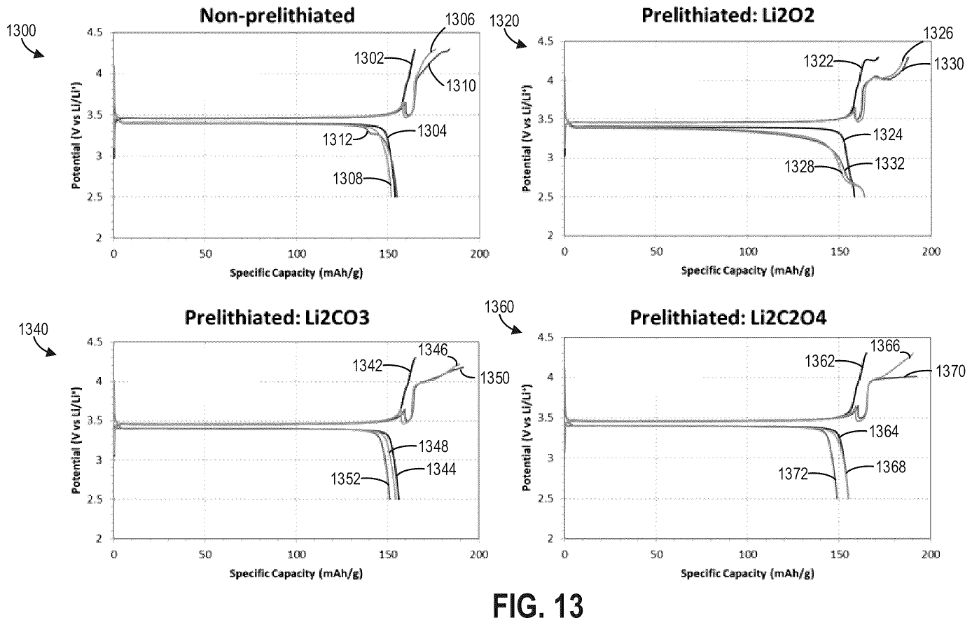

The following description relates to systems and methods for cathode pre-lithiation using a redox mediator. The redox mediator may promote decomposition of a cathode pre-lithiation material to release the additional lithium cations in the lithium ion battery. The redox mediator may be a molecular compound added to and soluble in an electrolyte of the lithium ion battery as shown in FIG. 1. The redox mediator may facilitate the decomposition of the cathode pre-lithiation material when voltage above a voltage threshold is applied to the lithium ion battery. The lithium ion battery shown in FIG. 1 may be prepared and pre-lithiated as described in the method of FIG. 2. 2,5-di-tert-butyl-1,4-dimethoxybenzene (DDB) may be an exemplary embodiment of the redox mediator for pre-lithiation of lithium iron phosphate (LFP) cathode materials using Li₂O₂, Li₂CO₃, and/or Li₂C₂O₄ cathode pre-lithiation materials. The LFP/DDB system is used herein to practically measure use of the redox mediator for pre-lithiation. FIGS. 3-4 show results of applying voltage to half cells including cathode pre-lithiation material with DDB in the electrolyte. FIGS. 5-6 show results of pre-lithiating half cells including LFP cathodes with and without pre-lithiation material and with and without DDB included in the electrolyte. FIGS. 7-11 show results of pre-lithiation of coin cell batteries including LFP cathodes with and without pre-lithiation material and with and without DDB. Both pre-lithiation behavior and resulting battery stability are shown. Pre-lithiation material may be added to a cathode of a battery cell in two different battery constructions, both of which may be efficiently decomposed by DDB as shown in FIG. 12. Effective decomposition of the pre-lithiation material may depend on a pre-lithiation charge rate, concentration of the redox mediator, and cell geometry of the battery. FIGS. 13-16 show effects of controlling these variables for the LFP/DDB/cathode pre-lithiation material system, using the coin cell batteries in comparison to single layer pouch (SLP) cell batteries as examples of changing cell geometries.

Turning now to FIG. 1, an illustration 100 of cathode pre-lithiation using a redox mediator is shown. Illustration 100 shows a simplified diagram of an uncharged lithium ion battery (LIB) 102. It is herein understood that the systems and methods for cathode pre-lithiation using the redox mediator are not particularly limited by battery architecture and LIB 102 may include stacked electrodes or wound electrodes and may be constructed as a prismatic cell, pouch cell, coin cell, among others. LIB 102 includes a cathode 104 and an anode 106 separated by a separator 108. Cathode 104, anode 106, and separator 108 may be positioned within a housing 110. Cathode 104 and anode 106 may be spaced apart from each other by an interelectrode distance 112.

Anode 106 may include anode active material capable of intercalating and deintercalating lithium ions. For example, anode active materials may include one or more of graphite, silicon, silicon alloys, and silicon oxides, among others. In some examples, the anode active material may further include hard and/or soft carbons, alloys (including alloys of silicon, phosphorous, tin, aluminum, and magnesium, among others), metal oxides (including Fe₂O₃, Co₃O₄, SnO₂), alkali metals including lithium or lithium free materials.

Cathode 104 may include a lithium ion battery cathode active material, such as one or more of lithium iron phosphate, lithium nickel manganese cobalt oxide, lithium nickel cobalt aluminum oxide, and lithium cobalt oxide, among others. Cathode 104 may additionally include carbon additives and polymer binders. The carbon additives and polymer binders may be interspersed with the cathode active material and may, in some examples, be demanded for battery operation and pre-lithiation. Carbon additives may, for example, include activated carbon particles. Polymer binders may be selected to bind particles of the cathode to each other and to a current collector.

Cathode 104 may further include a cathode pre-lithiation material 116. Cathode pre-lithiation material 116 may be in the form of particles and may be formed of one or more of Li₂O₂, Li₂CO₃ and Li₂C₂O₄. Additionally or alternatively, cathode pre-lithiation material 116 may be formed of one or more of Li₂S, Li₂O, Li₂C₄O₆, Li₃N, Li₂O/metal composite (e.g., Li₂O/Co), Li₂S/metal composites (e.g., Li₂S/Co), LiF/metal composites (e.g., LiF/Co), and lithium metal oxides (e.g., Li₂NiO₂ Or Li₅FeO₄). In one example, the cathode active material may be in the form of particles and the cathode pre-lithiation material particles may be mixed with cathode active material particles to be dispersed between the cathode active material particles within a coating. In an alternate example, the cathode active material may be in the form of particles and the cathode pre-lithiation material particles may be mixed with cathode active material particles to form a coating of pre-lithiation material particles surrounding each cathode active material particle. In another alternate example, the cathode active material particles and pre-lithiation material particles may comprise separate material layers (e.g., coatings) of cathode 104.

Cathode 104 of the uncharged lithium-ion battery 102 may not be charged. Not being charged may be a pristine state of cathode 104 following construction of the battery where external voltage has not been applied to the cathode 104. For this reason, the cathode pre-lithiation material 116 may be present and not yet oxidized to provide the additional lithium ions.

Separator 108 may be positioned between cathode 104 and anode 106. Separator 108 may be electrically insulating and ionically conducting. Housing 110 may also hold an electrolyte 114. Electrolyte 114 may include a solvent, lithium salts, and a redox mediator (RM). The solvent may be a carbonate solvent. For example, the carbonate solvent may include one or more of ethylene carbonate, propylene carbonate, butylene carbonate, diethyl carbonate, dimethyl carbonate, ethyl methyl carbonate, among others. The lithium salt may be one or more of, but not limited to, LiPF₆ and lithium bis(fluorosulfonyl)imide. Electrolyte 114 may be in direct fluid contact with both cathode 104 and anode 106.

The redox mediator (shown as RM in FIG. 1) may be a compound selected to mediate decomposition of the cathode pre-lithiation material 116 into lithium ions. The redox mediator may be soluble in electrolyte 114 and may have a redox potential that is higher than a redox potential of the cathode pre-lithiation material 116, outside of an operating voltage window of the cathode active material, and lower than an upper voltage limit of the lithium ion battery. In some examples, the redox mediator may be a molecular compound. A molecular compound may be added to the electrolyte without introducing unwanted spectator ions. Further, when not oxidized or reduced, the molecular compound may be neutral in the electrolyte and may not interfere with normal chemistry of the battery, unlike a spectator ion or ionic redox mediator which may compete with lithium for intercalation or otherwise interfere with movement of lithium ions. In examples where the redox mediator is an ionic salt, the ionic salt may include lithium and act as both a lithium salt and a redox mediator in the battery cell. For example, the redox mediator may be Li₂B₁₂H₁₂₋ₓFₓ (x=9 or 12), which is both a redox mediator and a lithium salt.

As one example, the redox mediator may be 2,5,-di-tert-burtyl-1,4-dimethoxybenzene (DDB). DDB may have an oxidation potential of 3.9V relative to Li/Li⁺, which is higher than the redox potentials of Li₂O₂ and Li₂CO₃, and is soluble in carbonate solvents. Additionally, 3.9V is higher than an upper operating voltage of LFP and lower than a maximum cutoff voltage of the lithium ion battery cell. However, DDB may not be used as the redox mediator in a lithium ion battery including lithium nickel manganese cobalt oxide (NMC) as the cathode active material. The operating voltage of NMC is between 2.5V and 4.3V relative to Li/Li⁺, thereby causing undesired oxidation and reduction of redox mediator during battery operation if DDB is used as the redox mediator, having the redox potential of 3.9V. Additionally, DDB⁺ may have an oxidation potential of 4.2V relative to Li/Li⁺ which is higher than the redox potentials of Li₂O₂ and Li₂CO₃ and higher than the operating potential of LFP and lower than a maximum cutoff voltage of the lithium ion battery cell.

Redox mediators may include halide molecules such as, but not limited to I₂ and Br₂. Redox mediators may include metallocenes such as, but not limited to (C₅H₅)₂Fe. Redox mediators may include metal phthalocyanines such as, but not limited to, cobalt (II) phthalocyanine. Redox mediators may further include dihydrophenazines, phenothiazines, pyrene, dimethoxybenzene derivatives, and anisole. Redox mediators may further include thianthrene and derivatives thereof, oxanthrene and derivatives thereof. Redox mediators may further include 2,2,6,6,-tetramethylpiperinyloxide (TEMPO) and derivatives thereof such as, but not limited to 4-oxo-TEMPO and 4-cyano-TEMPO. Redox mediators may further include triphenylamine, 6,7-Dimethoxy-1,1,4,4-tetramethyl-1,2,3,4-tetrahydronaphthalene, 2-(pentafluorophenyl)-tetrafluoro-1,2,3-benzodioxaborole (PFPTFBB), 1,4,di-tert-burtyl-2,5,-bis(2,2,2,-trifluoroethyox) benzene. Redox mediators may further include ionic compounds which are also lithium salts, such as, but not limited to, Li₂B₁₂H₁₂₋ₓFₓ (x=9 or 12).

The redox mediator may be included in electrolyte 114 at a concentration in a range of 1 mM up to 100 mM. In some examples, the concentration of redox mediator may be in a range of 5 mM up to 50 mM. Concentration of the redox mediator may affect the voltage and duration of the pre-lithiation process as described below.

During pre-lithiation as shown in illustration 100, a voltage source 118 is applied to lithium ion battery 102 to flow electrons towards anode 106, as shown by arrows 120. The redox mediator (RM) may be oxidized by the applied voltage (e.g., of voltage source 118) being above the redox potential of the redox mediator to form oxidized redox mediator (RM⁺). RM⁺ may then act as an oxidizing agent to oxidize cathode pre-lithiation material 116, thereby causing decomposition of cathode pre-lithiation material 116 and release of lithium ions. In some examples, RM⁺ may be reduced back to RM. In such examples, as long as the voltage above the redox potential of RM is applied, RM⁺ may be continuously regenerated within electrolyte 114 from RM. In this way, the redox mediator acts as a catalyst to decompose cathode pre-lithiation material 116. In alternate examples, RM⁺ may undergo further reactions to form side products that do not have the same electrochemical activity as RM. In this way, RM may be consumed and not regenerated to form RM. In such examples RM⁺ acts a redox mediator but not as a catalyst. In either example, because the redox mediator is dissolved in the liquid electrolyte, intimate fluid contact between the cathode pre-lithiation material 116 on the cathode 104 and the redox mediator may be readily established and maintained. In this way, the redox mediator may act as an inhomogeneous redox mediator.

Pre-lithiation as illustrated in illustration 100 may be performed as part of a battery manufacturing process and may not occur during normal operation (e.g., charging and discharging) of pre-charged lithium ion battery 103 by a consumer. Illustration 150 shows lithium ion battery 102 under normal operating conditions. The cathode pre-lithiation material 116 may be substantially (e.g., within 5%) fully decomposed to lithium ions and may no longer be present on cathode 104 nor elsewhere in lithium ion battery 102. Pre-lithiation may increase a lithium inventory of cathode 104. In this way, a capacity and stability of the pre-lithiated lithium ion battery 103 may be greater than a lithium ion battery that is not pre-lithiated. Redox mediator (RM) may remain in electrolyte 114 during operation. However, because the redox mediator is selected with a redox potential outside of the normal operation voltage range of the lithium ion battery, the redox mediator may not be oxidized or reduced during normal operation and may remain inert and inactive in the electrolyte. That is, the voltage applied by voltage source 118 in illustration 100 for pre-lithiation may be different than the voltage applied by voltage source 118 in illustration 150 for operation such that the redox mediator is active during pre-lithiation and inert and inactive during subsequent operation. If the redox potential of the redox mediator is within the operational voltage of the lithium ion battery, unwanted side reactions of the redox mediator may occur during normal battery operation which may decrease performance (e.g., capacity and/or stability) of the battery.

Turning now to FIG. 2 a flowchart of method 200 for preparing and pre-lithiating a cathode of a lithium ion battery, such as lithium ion battery 102 of FIG. 1 is shown. At 202, method 200 includes preparing a lithium ion battery cathode, the lithium ion battery cathode including cathode active material, cathode pre-lithiation material, binder, and conductive carbon additives. The binder and conductive carbon additives may each be included in a range of from 1% to 2% by weight. Both the cathode active material and cathode pre-lithiation material may be in the form of roughly spherical particles. The cathode may be an example of cathode 104 of FIG. 1. The cathode pre-lithiation material particles may be an example of cathode pre-lithiation material 116 shown in FIG. 1. In one example, the cathode pre-lithiation material particles may be a selected particle size to increase dispersion among cathode active material particles and increase reactivity. Cathode pre-lithiation material particles may have 90% of the particle volume exhibiting a diameter (D90) of less than 1.0 μm. In further examples the D90 of the cathode pre-lithiation material particles may be less than 0.5 μm. A combination of milling and/or sieving may be used to reach the desired cathode pre-lithiation particle D90. Solvent, such as but not limited to N-methyl-2-pyrrolidone (NMP), may be added to the cathode pre-lithiation material particles before milling and/or sieving to assist in particle handling.

In one example, preparing the lithium ion battery cathode may include first preparing a slurry including cathode active material particles, binder, and conductive carbon dispersed in NMP. The cathode pre-lithiation material particles, prepared to a desired size as described above, may be added to the slurry and dispersed by mixing. Mixing time and temperature may be tuned to fully disperse the cathode pre-lithiation material particles and cathode active material particles. In examples where the cathode pre-lithiation material particles are air sensitive (e.g., Li₂O₂), exposure to ambient air may be limited. The slurry may be tape cast onto a cathode current collector using methods such as, but not limited to, doctor blading and slot-die coating. The cast film may then be heated to dry the electrode followed by calendering to increase density and overnight vacuum drying to remove residual moisture. The cast cathode layer may include cathode active material in range of 90 wt. % up to <100 wt. %. In some examples the cathode active material may comprise 94 wt. % up to 98 wt. %. The cast cathode layer may include cathode pre-lithiation material in a range of >0 wt. % up to 6 wt. %. In some examples, the cathode pre-lithiation material may comprise 1 wt. % up to 4 wt. %. In some examples, the cathode active material is interspersed with and completely surrounded by the cathode pre-lithiation material in the cathode.

In an alternate example, preparing the lithium ion battery cathode may include preparing a first slurry including cathode active material particles, binder, and conductive carbon dispersed in a first amount of NMP. The cathode pre-lithiation material particles, prepared to a desired size as described above may be dispersed in a second amount of NMP along with conductive carbon to form a second slurry. Binder may not be added to the second slurry to prevent undesired reactions between the cathode pre-lithiation particles and the binder. Mixing time and temperature may be tuned to fully disperse the cathode pre-lithiation material particles and cathode active material particles. In examples where the cathode pre-lithiation material particles are air sensitive (e.g., Li₂O₂), exposure of the second slurry to ambient air may be limited. The first slurry may be tape cast onto a cathode current collector using techniques such as, but not limited to, doctor blading and slot-die coating. The cast film may then be heated to dry the electrode. The second slurry may be tape cast on top of the dried electrode using techniques such as, but not limited to doctor blading and slot-die coating. The electrode may then be heated to remove residual moisture, calendered to increase density, and vacuum dried overnight to remove residual moisture. In the alternate example, the cathode active material and the cathode pre-lithiation material may be included in adjacent discreet layers of the cathode.

At 204, method 200 includes preparing an anode of the lithium ion battery with an active material. The anode may be an example of anode 106 of FIG. 1. The anode may be prepared by forming a slurry of the anode active material, such as the materials described above with respect to FIG. 1, and casting the slurry onto an anode current collector to form the anode. The anode may be dried to remove residual moisture.

At 206, method 200 includes preparing electrolyte by mixing lithium salt and redox mediator in solvent. In one example, the solvent may be an organic solvent. In further examples, the organic solvent may be a carbonate solvent. The electrolyte may be an example of electrolyte 114 described above with respect to FIG. 1. The redox mediator may be included in addition to the salt in a concentration range as described above along with the lithium salt in a concentration range to promote conductivity of lithium through the electrolyte. Additionally or alternatively, the lithium salt may be a redox mediator.

At 208, method 200 includes constructing a lithium ion battery cell with the prepared cathode, anode, and electrolyte. The lithium ion battery cell may further include a porous separator membrane, such as separator 108 of FIG. 1. Constructing the battery cell may follow known manufacturing steps for lithium ion batteries such as, but not limited to punching, slitting, tabbing, stacking, winding, sealing, drying, filling, wetting, aging, forming, and degassing.

At 210, method 200 includes pre-charging the lithium ion battery cell to a pre-charging cutoff voltage at a pre-charging rate. Pre-charging may substantially (e.g., within 5%) extract all labile lithium ions from the cathode. Pre-charging may be performed at the pre-charging rate. The pre-charging rate may be a slow rate. For example, the pre-charging rate may be C/10, where C is equivalent to a charge capacity of the lithium ion battery in Ah. Pre-charging may include charging to a charging cutoff voltage. The charging cutoff voltage may be selected based on the cathode active material. For example, the charging cutoff voltage of a battery including LFP as the cathode active material may be 3.65V.

At 212, method 200 includes pre-lithiating the lithium ion battery by charging to a pre-lithiation cutoff voltage or charging above the redox potential of the redox mediator for a threshold length of time above a minimum pre-lithiation rate. The threshold length of time may be a time demanded for decomposition of the cathode pre-lithiation particles by the redox mediator. The minimum pre-lithiation rate may be faster than the pre-charging rate. Decomposition of the cathode pre-lithiation material may provide additional lithium ions to the lithium ion battery as described above with respect to FIG. 1.

The minimum pre-lithiation rate demanded for pre-lithiation may be calculated using equation 1 below.

$${i}_{app , min} = {i}_{d} = {nFD}_{eff} \frac{c}{l} \qquad ( 1 )$$

i_{app,min} is the minimum pre-lithiation current which is equivalent to the maximum shuttle current supplied by diffusion of the redox mediator between the electrodes (i_{d}). n is the electron transfer number, F is the Faraday constant, D_{eff} is the effective diffusivity of the redox mediator, C is the concentration of the redox mediator, and l is an interelectrode spacing (e.g., space between cathode and anode, such as interelectrode distance 112 of FIG. 1). D_{eff} may depend on the specific redox mediator molecule and a porosity and tortuosity of the separator. The D_{eff} may be determined by standard experimental techniques, such as cyclic voltammetry. The minimum applied current may be a current below which the redox mediator forms a redox shuttle, thereby limiting cell voltage until the redox mediator is eventually degraded. Pre-lithiating above the minimum current allows the cell voltage to reach the pre-lithiation cutoff voltage once the decomposition of the pre-lithiation additive is complete, thereby marking a clear trigger for ending pre-lithiation and more efficiently decomposing the cathode pre-lithiation material and reducing a demanded time for pre-lithiation. Additionally, accessing higher voltages may generate doubly or triply charged redox mediator species, enabling more efficient decomposition of the cathode pre-lithiation material.

An applied current during pre-lithiation may be an integer multiple of the minimum pre-lithiation current given by equation 2 below.

$${i}_{app} = x \cdot {i}_{app , min} \qquad ( 2 )$$

x is an integer. A value of x may be in a range of 1-5. In some examples x is in a range of 2-5. The pre-lithiation current may be applied until the pre-lithiation cutoff voltage is reached. A maximum pre-lithiation cutoff voltage may be based on electrolyte stability, including the electrolyte solvent and lithium salt used. In one example, the maximum pre-lithiation cutoff voltage may be 4.5V for a combination of LiPF₆ lithium salts in carbonate electrolyte solvent. The selected pre-lithiation cut-off voltage may be below the maximum pre-lithiation cutoff voltage and above the oxidation potential of the redox mediator. In some examples, the pre-lithiation cut-off voltage may be selected to be as low as possible while still reliably above the potential of the redox mediator. For example, the selected pre-lithiation cutoff voltage may be 4.4V or 4.3V. The threshold time may be selected based on the charging rate. For example, the threshold time may decrease as the charging rate increases. Method 200 ends.

FIGS. 3-16 show results of testing half cells and batteries with and without DDB included in the electrolyte. For each test, the electrolyte includes LiPF₆ dissolved in a mixture of carbonates. If DDB is included, it is added at a concentration of 0.05M unless otherwise noted. Further, each charging/discharging of the half cells and batteries is performed at 25° C.

Turning now to FIG. 3, a graph 300 is shown of cell potential as a function of percent theoretical capacity. The percent theoretical capacity is a calculated value based on the amount of lithium contained in the pre-lithiation additive.

Plots of graph 300 are collected from coin half cells constructed with cathodes formed of cathode pre-lithiation material particles and conductive carbon, without added cathode active material. A pre-lithiation current was applied to the half cells at a rate of C/10 until either the upper cutoff voltage of 4.3V or a 20 hour threshold time was reached.

A first plot 302 corresponds to a half cell including Li₂CO₃ cathode pre-lithiation material, a second plot 304 corresponds to a half cell including Li₂O₂ cathode pre-lithiation material, and a third plot 306 corresponds to a half cell including Li₂C₂O₄ cathode pre-lithiation material. As shown in graph 300, the half cells including Li₂O₂ and Li₂CO₃ both reached the cutoff voltage of 4.3V indicated by line 308. The half cell including Li₂C₂O₄ did not reach the cutoff voltage and current was applied until the 20 hour threshold time was reached.

After current was applied to collect the plots shown in FIG. 3, the half cells were disassembled and the material remaining on the cathodes was analyzed using X-ray diffraction (XRD). XRD diffractograms of collected cathode material are shown in graph 400 of FIG. 4 and compared to XRD spectra of the cathode material before the pre-lithiation current was applied (e.g., charged). A peak at ˜45° is present in each XRD diffractogram and is from the aluminum current collector.

A first plot 402 corresponds to the charged Li₂C₂O₄ cathode and a second plot 404 corresponds to the pristine Li₂C₂O₄ cathode, before charging. As shown in graph 400, XRD peaks associated with the Li₂C₂O₄ are diminished in intensity, but still present indicating only partial degradation of the Li₂C₂O₄ during the pre-lithiation. A third plot 406 corresponds to charged Li₂CO₃ and a fourth plot 408 corresponds to the pristine Li₂CO₃ cathode before charging. As shown in graph 400, the XRD peaks associated with the Li₂CO₃ in plot 408 are substantially gone in plot 406, indicating full degradation of the Li₂CO₃. A fifth plot 410 corresponds to the charged Li₂O₂ cathode and a sixth plot 412 corresponds to the pristine Li₂O₂ cathode before charging. As shown in graph 400, the XRD peaks associated with Li₂O₂ in plot 412 are substantially gone in plot 410 indicating full degradation of Li₂O₂.

Half cells were then constructed to show the effect of the combination of redox mediator and cathode pre-lithiation material particles on capacity and efficiency of the half cell. Turning now to FIGS. 5-6, a first graph 500 shows potential as a function of specific capacity for a control half cell constructed with a cathode including LiFePO₄ (LFP), conductive carbon, and PVDF binder without cathode pre-lithiation material particles. Lithium metal was used as an anode in each of the half cells discussed herein. First graph 500 compares first cycle charging of the cell with and without DDB included in the electrolyte. The half cells without DDB included in the electrolyte shown in graph 500 were charged at a rate of C/10 to a charging cutoff voltage of 3.8 V and discharged to a lower cutoff voltage of 2.5 V. The half cell with DDB included in the electrolyte was charged at a rate of C/10 to a pre-lithiation cutoff voltage of 4.3V and discharged to a lower cutoff limit of 2.5V. The base electrolyte includes LiPF₆ salts dissolved in an organic carbonate solvent. A first plot 502 corresponds to charging the half cell without DDB and a second plot 504 corresponds to discharging the half cell without DDB. A third plot 506 corresponds to charging the half cell with DDB in the electrolyte and a fourth plot 508 corresponds to discharging the half cell with DDB in the electrolyte.

A second graph 550 compares first cycle charging and discharging of a half cell with a cathode comprising LFP and Li₂O₂ as well as PVDF binder and conductive carbon cast from a single slurry, with and without DDB. The half cells shown in graph 550 were charged at a rate of C/10 to an upper cutoff voltage of 4.3V and discharged at a rate of C/10 to a lower cutoff voltage of 2.5V. A first plot 552 corresponds to charging the half cell without DDB in the electrolyte and a second plot 554 corresponds to discharging the half cell without DDB in the electrolyte. A third plot 556 corresponds to charging the half cell with DDB in the electrolyte and a fourth plot 558 corresponds to discharging the half cell with DDB in the electrolyte. As shown in graph 550, a shape of the charging curve is changed when DDB is present in the electrolyte due to the electrochemical reactions between the Li₂O₂ and the DDB.

FIG. 6 shows graphs 600 and 650 comparing first cycle charging and discharging with and without DDB in the electrolyte for half cells with cathodes prepared as described above but replacing Li₂O₂ with Li₂CO₃ cathode pre-lithiation material and Li₂C₂O₄ cathode pre-lithiation material respectively. The half cells shown in both graph 600 and 650 were charged to an upper cutoff voltage of 4.3V at a rate of C/10 and discharged to lower cutoff voltage of 2.5V at rate of C/10. A first plot 602 corresponds to charging the half cell without DDB in the electrolyte and second plot 604 corresponds to discharging the half cell without DDB in the electrolyte. A third plot 606 corresponds to charging the half cell with DDB in the electrolyte and fourth plot 608 corresponds to discharging the half cell with DDB in the electrolyte. A first plot 652, of graph 650, corresponds to charging the half cell without DDB in the electrolyte and a second plot 654 corresponds to discharging the half cell without DDB in the electrolyte. A third plot 656 corresponds to charging the half cell with DDB in the electrolyte and a fourth plot 658 corresponds to discharging the half cell with DDB in the electrolyte. Similar to graph 550, both graph 600 and 650 show charging curves of the half cells change in shape with DDB present in the electrolyte.

Table 1 below summarizes the first charge capacity (FCC), first discharge capacity (FDC), and first cycle efficiency (FCE) determined from the plots shown in FIGS. 5-6.

TABLE 1
Summary of half cell first cycle performance values.

| | Non- | Non- | Non- | | | |
|---|---|---|---|---|---|---|
| | prelithiated | prelithiated | prelithiated | Li₂O₂ | Li₂CO₃ | Li₂C₂O₄ |
| | w/out DDB | w/out DDB | w/DDB | w/DDB | w/DDB | w/DDB |
| | (3.8 V) | (4.3 V) | (4.3 V) | (4.3 V) | (4.3 V) | (4.3 V) |
| FCC | 160 | 164 | 278 | 195 | 203 | 197 |
| (mAh/g) | | | | | | |
| FDC | 153 | 153 | 160 | 165 | 161 | 161 |
| (mAh/g) | | | | | | |
| FCE | 95.6 | 93.3 | 57.6 | 84.6 | 79.3 | 81.7 |
| (%) | | | | | | |

As shown in table 1, adding the pre-lithiation material and DDB results in an increase in first charge capacity without decreasing the first discharge capacity. As expected, first charge efficiency decreases when the pre-lithiation material and DDB are present due to the irreversibility of the pre-lithiation decomposition reaction.

To further determine effects of DDB and pre-lithiation cathode material on a performance of the lithium ion battery, full coin cell batteries were constructed with cathodes prepared as described above with respect to the half cells and using a graphite anode. The coin cell batteries were tested with and without DDB in the electrolyte.

Turning now to FIG. 7, a first graph 700 shows first charging and discharging curves for a coin cell battery including cathode material (LFP) but without cathode pre-lithiation material and with electrolyte that does not include DDB. First charges and discharges of the full cell without cathode pre-lithiation material were performed in the same way as with the half cell described above with respect to graph 500 of FIG. 5. A first plot 702 corresponds to charging the battery cell and second plot 704 corresponds to discharging the battery cell. A second graph 750 shows first charging and discharging curves for a lithium ion battery including LFP and without cathode pre-lithiation material and with electrolyte including DDB. A first plot 752 corresponds to charging the battery cell and a second plot 754 corresponds to discharging the battery cell.

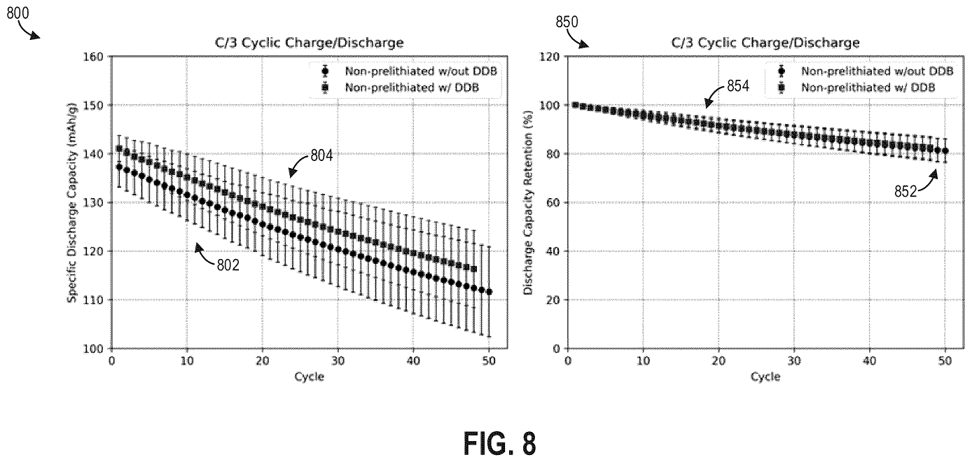

After a first charging and discharging, the battery cells without cathode pre-lithiation material but with and without DDB included in the electrolyte are repeatedly charged and discharged for 50 cycles at a rate of C/3 with a charging cutoff voltage of 3.7V, a current cutoff of C/20, and a lower cutoff voltage of 2.5V. Specific capacity of the battery cells are shown in graphs 800 and 850 of FIG. 8. Graph 800 shows specific discharge capacity over the 50 cycles and graph 850 shows discharge capacity percent retention over the 50 cycles. Circular data points 802 and 852 each correspond to the battery cell without DDB included in the electrolyte and square data points 804 and 854 each correspond to the battery cell with DDB included in the electrolyte. As shown in graphs 800 and 850, without the inclusion of the cathode pre-lithiation material, there are no significant differences (e.g., no difference outside the error bars) in the cycling stability of the battery cells with and without DDB included in the electrolyte. Based on the data shown in FIG. 8, the DDB reacts with the cathode pre-lithiation material and does not degrade the battery performance when the cathode pre-lithiation material is no longer present.

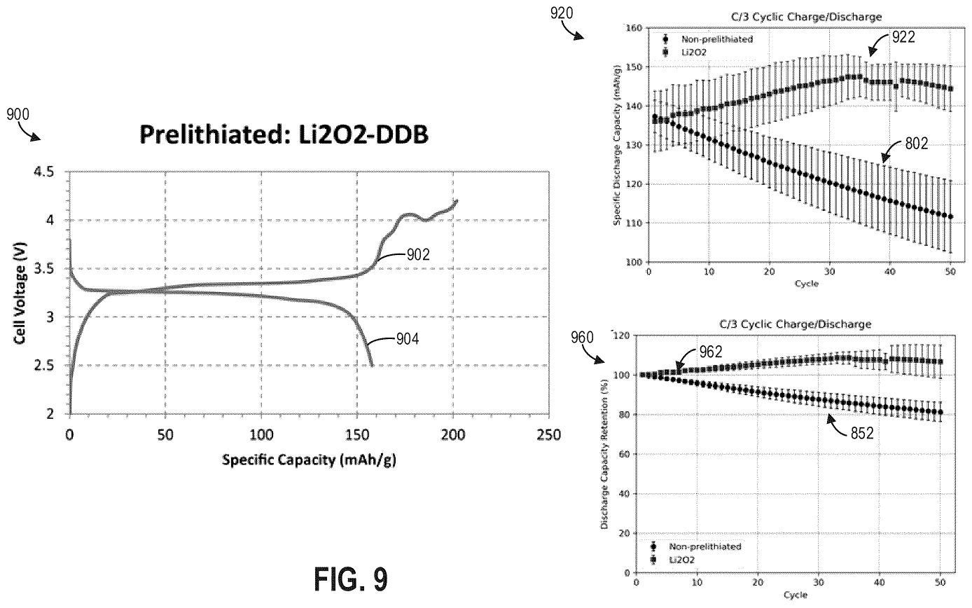

Turning now to FIGS. 9-11, first charging/discharging and cycling stability for coin cell batteries constructed using a graphite anode and a cathode including LFP as the cathode active material and different cathode pre-lithiation materials are shown. Stability of the battery cell pre-lithiated with the DDB redox mediator is compared to the battery cell that does not include pre-lithiation material or DDB (e.g., data points 802 and 852 of FIG. 8). The battery cells including Li₂O₂ and LiCO₃ as the pre-lithiation material were each subjected to a first charge to a cutoff voltage of 4.2V and discharged to a lower cutoff voltage of 2.5V. The battery cell including Li₂C₂O₄ as the cathode pre-lithiation material was subjected to a first charge to a cutoff voltage of 4.3V and discharged to a lower cutoff voltage of 2.5V. First charges and discharges for each of the pre-lithiated battery cells were performed at a rate of C/10. The cycling stability was then tested in the same manner as the non-pre-lithiated battery cells described above with respect to FIG. 8.

Turning first to FIG. 9, a graph 900 shows cell voltage as a function of specific capacity for the first charging and discharging of the battery cell comprising Li₂O₂ included in the cathode and DDB included in the electrolyte. A first plot 902 corresponds to charging the battery cell and a second plot 904 corresponds to discharging the battery cell. Graph 920 of FIG. 9 shows specific discharge capacity of 50 cycles and graph 960 shows discharge capacity percent retention over the 50 cycles. Square data points 922 and 962 of graphs 920 and 960, respectively, correspond to the battery including the Li₂O₂ and DDB. Graphs 920 and 960 include data points 802 and 852, respectively, of FIG. 8 for comparison. As shown in graphs 920 and 960, the specific discharge capacity and discharge capacity retention of the battery cell including the Li₂O₂ and DDB increases over the first several cycles before plateauing. Such behavior is indicative of successful cathode pre-lithiation during the first charging/discharging cycles.

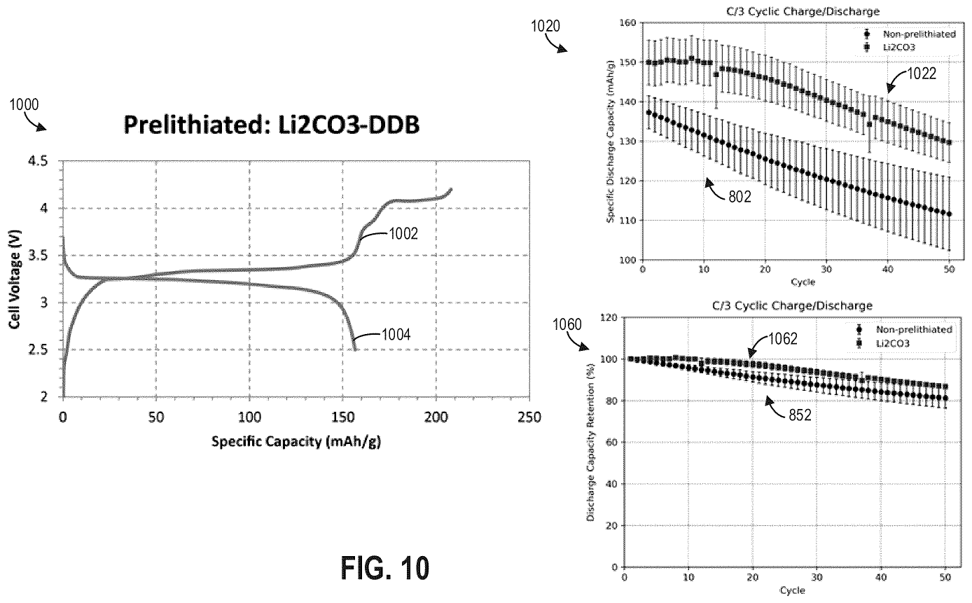

Turning now to FIG. 10, a graph 1000 shows cell voltage as a function of specific capacity for the first charging and discharging of the battery cell comprising Li₂CO₃ included in the cathode and DDB included in the electrolyte. A first plot 1002 corresponds to charging the battery cell and a second plot 1004 corresponds to discharging the battery cell. Graph 1020 of FIG. 10 shows specific discharge capacity of 50 cycles and graph 1060 shows discharge capacity percent retention over the 50 cycles. Square data points 1022 and 1062 of graphs 1020 and 1060, respectively, correspond to the battery including the Li₂CO₃ and DDB. Graphs 1020 and 1060 include data points 802 and 852, respectively, of FIG. 8 for comparison. As shown in graphs 1020 and 1060, the specific discharge capacity and discharge capacity retention of the battery cell including the Li₂CO₃ and DDB is increased compared to the equivalent battery cell which does not include cathode pre-lithiation material.

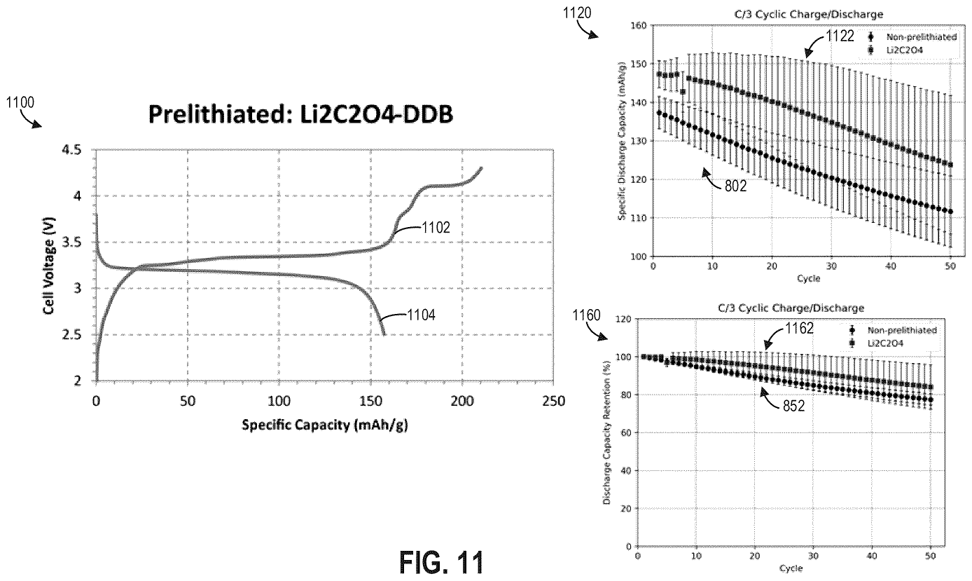

Turning now to FIG. 11, a graph 1100 shows cell voltage as a function of specific capacity for the first charging and discharging of the battery cell comprising Li₂C₂O₄ included in the cathode and DDB included in the electrolyte. A first plot 1102 corresponds to charging the battery cell and a second plot 1104 correspond to discharging the battery cell. Graph 1120 of FIG. 11 shows specific discharge capacity of 50 cycles and graph 1160 shows specific charging capacity over the 50 cycles. Square data points 1122 and 1162 of graphs 1120 and 1160, respectively, correspond to the battery including the Li₂C₂O₄ and DDB. Graphs 1120 and 1160 include data points 804 and 854, respectively, of FIG. 8 for comparison. As shown in graphs 1120 and 1160, the specific discharge capacity and discharge capacity retention of the battery cell including the Li₂C₂O₄ and DDB is increased compared to the equivalent battery cell which does not include cathode pre-lithiation material.

Table 2 below summarizes the FCC, FDC, and FCE determined from graphs 700, 750, 900, 1000, 1100 of FIGS. 7 and 9-11.

TABLE 2
Summary of full coin cell first cycle performance values.

| | Non- | Non- | | | |
|---|---|---|---|---|---|
| | prelith- | prelith- | | | |
| | iated | iated | Li₂O₂ | Li₂CO₃ | Li₂C₂O₄ |
| | w/out DDB - | w/DDB - | w/DDB - | w/DDB - | w/DDB - |
| | 3.8 V | 4.2 V | 4.2 V | 4.2 V | 4.2 V |
| FCC | 163 | 214 | 201 | 243 | 205 |
| (mAh/g) | | | | | |
| FDC | 144 | 153 | 155 | 152 | 152 |
| (mAh/g) | | | | | |
| FCE (%) | 88.6 | 71.5 | 76.8 | 62.0 | 74.3 |

Similar to the performance of the half cells, addition of the cathode pre-lithiation material with DDB included in the electrolyte results in an increase in FCC. For non-prelithiated cells, the lower FDC compared to half cells (Table 1 above) results from the irreversible losses that occur during the first cycle. In contrast, the pre-lithiated cells exhibit FDC values closer to those of the half cells (Table 1 above), indicating the first cycle irreversible losses have been compensated. Finally, the reduced FCE indicates the irreversibility of the pre-lithiation decomposition reaction.

Table 3 below summarizes the capacity retention over time determined from graphs 800, 850, 920, 960, 1020, 1060, 1120, and 1160 of FIGS. 8-11.

TABLE 3
Summary of full coin cell cyclic charge/discharge
experiments at 25° C. and C/3.

| | Non- | Non- | | | |
|---|---|---|---|---|---|
| | prelith- | prelith- | | | |
| | iated | iated | Li₂O₂ | Li₂CO₃ | Li₂C₂O₄ |
| | w/out DDB - | w/DDB - | w/DDB - | w/DDB - | w/DDB - |
| | 3.8 V | 4.2 V | 4.2 V | 4.2 V | 4.2 V |
| Cycle 50 | 112 | 116 | 144 | 130 | 130 |
| Specific | | | | | |
| Capacity | | | | | |
| (mAh/g) | | | | | |
| Cycle 50 | 81 | 82 | 107 | 87 | 87 |
| Capacity | | | | | |
| Retention | | | | | |
| (%) | | | | | |

Table 3 confirms that adding the combination of DDB in the electrolyte and cathode pre-lithiation material to the cathode results in both an increase in specific capacity over 50 cycles as well as increase in percent of capacity retention as compared to battery cells that do not include cathode pre-lithiation material even with DDB present.

As described above, the cathodes corresponding to the measurements presented in FIGS. 5-11 include a single layer of material including cathode active material particles surrounded by and interspersed with the cathode pre-lithiation material particles cast from a single slurry. Turning now to FIG. 12, a graph 1200 is shown comparing potential as a function of specific capacity for battery half cells constructed with cathode active material particles and Li₂O₂ cathode pre-lithiation materials in a single layer to battery half cells constructed with the cathode active material particles and the Li₂O₂ cathode pre-lithiation material particles in two separate, adjacent layers. Each of the half cells corresponding to the plots of graph 1200 include DDB in the electrolyte of the half cell. Further, each cell was charged at a rate of C/10 to an upper cutoff voltage of 4.3V and discharged at a rate of C/10 to a lower cutoff voltage of 2.5V.

A first plot 1202 corresponds to charging the half cell including the two separate layers and a second plot 1204 corresponds to discharging the half cell including the two separate layers. A third plot 1206 corresponds to charging the half cell including the single layer and a fourth plot 1208 corresponds to discharging the half cell including the single layer. A fifth plot 1210 corresponds to charging a control half cell which includes DDB in the electrolyte but does not include a cathode pre-lithiation material and a sixth plot 1212 corresponds to discharging the control half cell. Similar to the half cell including the single layer, the half cell including the cathode active material and cathode pre-lithiation material in two separate layers also shows a substantial increase in FCC compared to the non-pre-lithiated control. FIG. 12 shows that the redox mediator may be effective at decomposing the cathode pre-lithiation material in either of the two cathode and pre-lithiation material configurations (e.g., single mixed layer and two discreet layers).

Further, as discussed above with respect to method 200 and equation 1, both concentration of the redox mediator and the rate of pre-lithiation may affect the efficiency of pre-lithiation of the cathode material. Turning now to FIG. 13. graphs are shown which compare the potential as a function of specific capacity for a first charge/discharge cycle of half cells constructed with cathode active material (LFP) and different cathode pre-lithiation materials. The half cells may be prepared similarly to the half cells described above with respect to FIGS. 5-7. The half cells were prepared to include different reduced concentrations of DDB in the electrolyte and were pre-lithiated and/or charged at different rates.

A first graph 1300 corresponds to half cells without a cathode pre-lithiation material. A second graph 1320 corresponds to half cells including Li₂O₂ as the cathode pre-lithiation material. A third graph 1340 corresponds to half cells including Li₂CO₃ as the cathode pre-lithiation material. A fourth graph 1360 corresponds to half cells including Li₂CO₄ as the cathode pre-lithiation material.

First graph 1300 includes a first plot 1302 and a second plot 1304 corresponding to charging and discharging, respectively, of the control half cell including 10 mM DDB in the electrolyte to a cutoff voltage of 4.3V at a rate of C/10. First plot 1322 and second plot 1324 of second graph 1320, first plot 1342 and second plot 1344 of third graph 1340, and first plot 1362 and second plot 1364 of fourth graph 1360 each show charging and discharging curves corresponding to the same conditions for half cells including their respective cathode pre-lithiation material. Under the 10 mM DDB and C/10 charging conditions, only the half cell with the Li₂O₂ cathode pre-lithiation material showed a voltage plateau and an increase in FCC compared to the control (e.g., first graph 1300).

First graph 1300 includes a third plot 1306 and a fourth plot 1308 corresponding to charging and discharging, respectively, of the control half cell including 10 mM DDB in the electrolyte to a charging cutoff voltage of 3.65V at a rate of C/10 and the continuing to charge to the pre-lithiation cutoff voltage of 4.3V at a rate of C/50. Third plot 1326 and fourth plot 1328 of second graph 1320, third plot 1346 and fourth plot 1348 of third graph 1340, and third plot 1366 and fourth plot 1368 of fourth graph 1360 each show charging and discharging curves corresponding to the same conditions for half cells including their respective cathode pre-lithiation material. When the charging rate was decreased for pre-lithiation, each of the half cells including cathode pre-lithiation material shows an increase in FCC compared to the control without cathode pre-lithiation material shown in first graph 1300.

First graph 1300 includes a fifth plot 1310 and a sixth plot 1312 corresponding to charging and discharging, respectively, of the control half cell including 5 mM DDB in the electrolyte to a charging cutoff voltage of 3.65V at a rate of C/10 and the continuing to charge to the pre-lithiation cutoff voltage of 4.3V at a rate of C/100. Fifth plot 1330 and sixth plot 1332 of second graph 1320, fifth plot 1350 and sixth plot 1352 of third graph 1340, and fifth plot 1370 and sixth plot 1372 of fourth graph 1360 each show charging and discharging curves corresponding to the same conditions for half cells including their respective cathode pre-lithiation material. By lowering the pre-lithiation rate proportional to the DDB concentration, each of the half cells including cathode pre-lithiation material showed an increase in FCC compared to the control without cathode pre-lithiation material shown in first graph 1300. In this way, graphs 1300, 1320, 1340, 1360 of FIG. 13 show that adjusting pre-lithiation rate as described above with respect to method 200 results in effective pre-lithiation that increases the FCC of the battery cell.

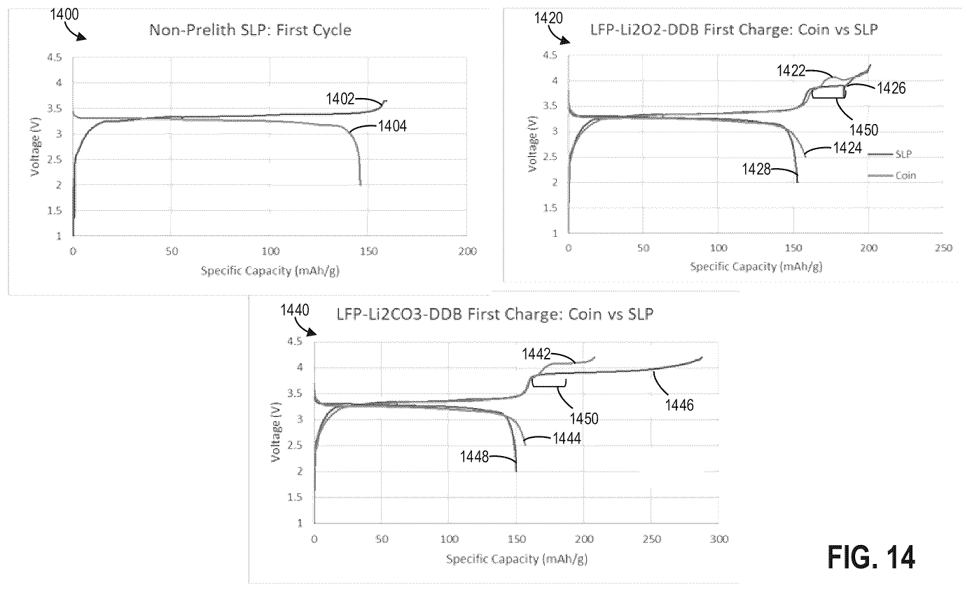

As described above, with respect to method 200 and equation 1, a minimum pre-lithiation rate is at least partially based on an interelectrode distance of the battery. The effect of interelectrode distance is demonstrated in FIG. 14. FIG. 14 compares voltage as a function of charge capacity for first charging/discharging of two different battery geometries: a single layer pouch (SLP) cell and a coin cell, where each battery geometry is constructed from the same cathode material. Coin cell batteries were measured providing the graphs shown in FIGS. 7-11, and were prepared using graphite anodes and with and without cathode pre-lithiation material as described above with respect to FIGS. 7-11. SLP cell batteries were also fabricated using graphite anodes. For each of the coin cell and SLP cell batteries, 50 mM DDB was added to the electrolyte. The SLP battery cells include a thinner separator than the coin cell batteries resulting in a shorter interelectrode spacing in the SLP battery cells than in the coin cell batteries.

FIG. 14 includes a first graph 1400 showing a charging plot 1402 and a discharging plot 1404 of a SLP cell battery including LFP cathode material but without cathode pre-lithiation material as a control. The control SLP cell battery shown in graph 1400 was charged to a charging cutoff voltage of 3.65V at a rate of C/10 and discharged to discharging cutoff voltage of 2.0V, also at a rate of C/10.

FIG. 14 includes a second graph 1420 showing charging and discharging of a coin cell battery and SLP cell battery including Li₂O₂ as the cathode pre-lithiation material. A first plot 1422 corresponds to a coin cell battery and a second plot 1424 corresponds to discharging the coin cell battery. A third plot 1426 corresponds to charging the SLP cell battery and a fourth plot 1428 corresponds to discharging the SLP battery cell. The plots of second graph 1420 were collected by charging both the SLP battery cell and coin battery cell at a rate of C/10 to a pre-lithiation cutoff voltage of 4.3V and discharging at rate of C/10 to discharging cutoff voltage of 2.0V.

FIG. 14 further includes a third graph 1440 showing charging and discharging of a coin cell battery and SLP cell battery including Li₂CO₃ as the cathode pre-lithiation material. A first plot 1442 corresponds to a coin cell battery and a second plot 1444 corresponds to discharging the coin cell battery. A third plot 1446 corresponds to charging the SLP cell battery and the fourth plot 1448 corresponds to discharging the SLP battery cell. The plots of second graph 1420 were collected by charging both the SLP battery cell and coin battery cell at a rate of C/10 to a pre-lithiation cutoff voltage of 4.3V and discharging at rate of C/10 to discharging cutoff voltage of 2.0V.

As shown in the graphs of FIG. 14, an increase in FCC and FDC for the SLP cell batteries shown in both graphs 1420 and 1440 is measured compared to the control without cathode pre-lithiation material shown in graph 1400. Further, the specific FDC values of the SLP cell batteries shown in graphs 1420 and 1440 are each lower than that the respective corresponding coin cell batteries. Further, the effect of decreasing interelectrode distance is also shown in a shape of the charging curves. A plateau at 3.9V shown by bracket 1450 is seen in both third plot 1426 of graph 1420 and third plot 1446 of graph 1400. The plateau may be attributed, in part, to a DDB redox shuttle process being extended due to the reduced interelectrode spacing of the SLPs.

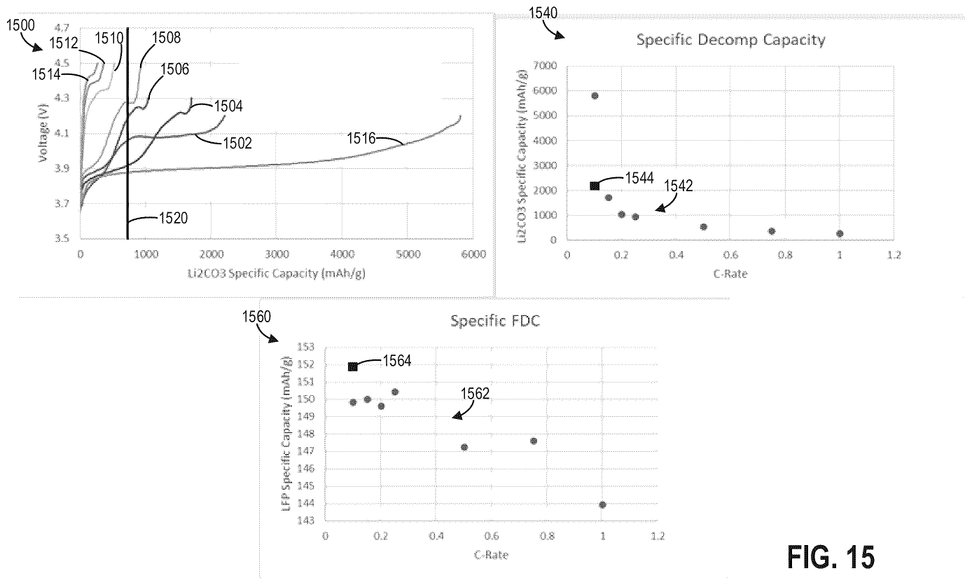

As further described with respect to method 200, adjusting a rate of pre-lithiation based on the interelectrode spacing may result in more efficient pre-lithiation by the combination of cathode pre-lithiation material and redox mediator. FIG. 15 shows graphs illustrating an effect of pre-lithiation rate on the battery cell. A first graph 1500 shows voltage as a function of specific capacity for a SLP cell battery as described above with respect to FIG. 14 including Li₂CO₃ as the cathode pre-lithiation material. The SLP cell was first charged to a charging cutoff voltage of 3.65V at a rate of C/10 (e.g., 0.1 C) and then pre-lithiated to an upper cutoff voltage of 4.3V or 4.5V. Charging curves were measured for pre-lithiation rates starting at 0.1 C up to 1.0 C. A first plot 1516 corresponds to 0.1 C, a second plot 1504 corresponds to 0.15 C, a third plot 1506 correspond to 0.2 C, fourth plot 1508 corresponds to 0.25 C, a fifth plot 1510 corresponds to 0.5 C, a sixth plot 1512 corresponds to 0.75 C, a seventh plot 1514 corresponds to 1.0 C. As a comparison, an eighth plot 1502 corresponds to pre-lithiating a corresponding coin cell battery including Li₂CO₃ to an upper cutoff voltage of 4.2V. For reference, a line 1520 corresponds to the theoretical charge capacity of Li₂CO₃. As shown in graph 1500, increasing the pre-lithiation rate results in a concomitant shortening of the DDB redox shuttle plateau at 3.9V and further, the plateau is not observed when the pre-lithiation rate is 0.5 C or higher. This indicates the formation of a redox shuttle process may be avoided with the use of higher pre-lithiation charge rates. SLP cells charged at rates of 0.25 C and higher were charged to an upper cutoff voltage of 4.5V and exhibited at plateau at around 4.2V to 4.45V attributed to a second electron transfer to the DDB.

Analysis of the data shown in first graph 1500 is further shown in second graph 1540 and third graph 1560. Second graph 1540 shows circle data points 1542 corresponding to the specific capacity as a function of pre-lithiation rate. A square data point 1544 corresponds to the corresponding coin cell comparison. As shown in second graph 1540, specific capacity decreases as the pre-lithiation rate increases. Pre-lithiating above a rate of 0.25 C resulted in a capacity below the theoretical rate of Li₂CO₃ being measured. Third graph 1560 shows specific FDC as a function of C-rate. Circle data points 1562 corresponding to the FDC determined for the charging curves of the SLP cell batteries is shown in graph 1500. A square data point 1564 corresponds to the corresponding coin cell battery for comparison. As shown in third graph 1560, the highest FDC is measured when the pre-lithiation rate is at or below 0.25 C and higher rates result in lower FDC.

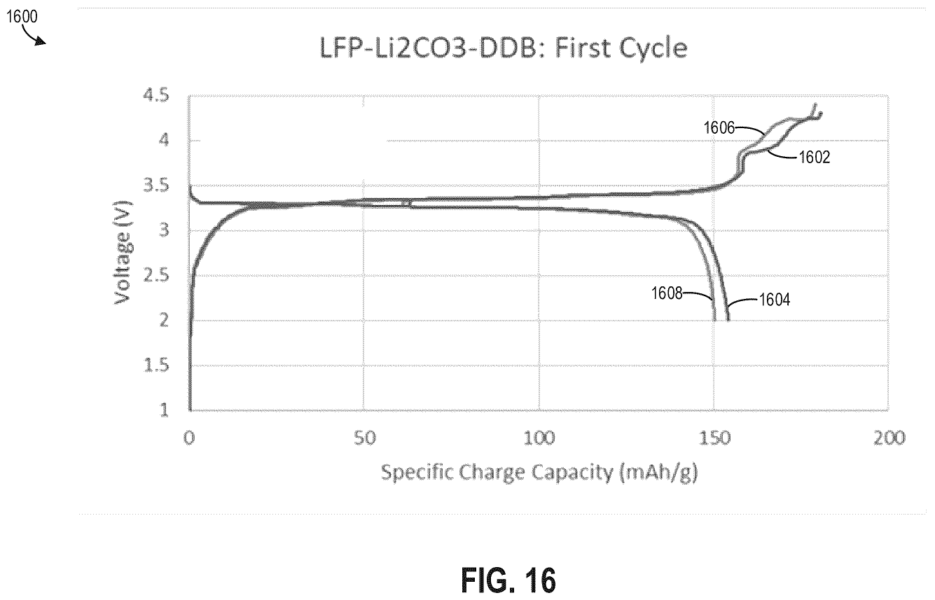

Concentration of redox mediator included in the electrolyte may also be used adjust a minimum pre-lithiation rate as discussed above. FIG. 16 shows a graph of 1600 of voltage as a function of specific capacity for a first charge/discharge cycle comparing the effect of DDB concentration in a SLP cell battery including LFP cathode active material and Li₂CO₃ cathode pre-lithiation material. A first SLP cell battery was prepared using 50 mM DDB in the electrolyte. The first SLP cell battery was charged to charging cutoff voltage at 3.65V and then charged to pre-lithiation cutoff voltage of 4.4V at a rate of 0.2 C and then discharged to a lower cutoff voltage of 2.0V at a rate of C/10. A first plot 1602 corresponds to charging of the first SLP cell battery and a second plot 1604 corresponds to discharging of the first SLP cell battery. A second SLP cell battery was prepared as the first SLP cell battery but including 100 mM DDB in the electrolyte. The second SLP cell battery was charged to the charging cutoff voltage at a rate of C/10 followed by charging to the pre-lithiation cutoff voltage at rate of 0.4 C, and then discharged to the lower cutoff voltage at rate of C/10. A third plot 1606 corresponds to charging the second SLP cell battery and a fourth plot 1608 corresponds to discharging the second SLP cell battery. From the plots shown in graph 1600, it is determined that for the second SLP cell battery an average Li₂CO₃ specific FCC above 3.65V was 949 mAh/g, or 131% of theoretical, and the LFP specific FDC was 150 mAh/g, a 3.0% increase compared to a non-prelithiated control but 2.4% lower than that exhibited for the first SLP cell battery.

The technical effect of method 200 is to increase the lithium inventory of a lithium ion battery relative to the amount of cathode active material by pre-lithiating the cathode at voltages that do not degrade the electrolyte by using a redox mediator dissolved in the electrolyte as an inhomogeneous pre-lithiation mediator. If selected to have a redox potential within a desired window, the redox mediator may efficiently decompose the cathode pre-lithiation material at pre-lithiation voltages and may not interfere with normal battery operation. Further, the rate of cathode pre-lithiation may be adjusted based on battery cell geometry and redox mediator concentration to most efficiently decompose the cathode pre-lithiation material.

The disclosure also provides support for an uncharged lithium ion battery, comprising: a cathode including cathode active material and cathode pre-lithiation material, wherein the cathode has not been charged, and an electrolyte including a redox mediator, wherein the electrolyte is in fluid contact with the cathode and wherein a redox potential of the redox mediator is higher than a redox potential of the cathode pre-lithiation material and the redox potential of the redox mediator is outside an operating voltage window of the cathode active material. In a first example of the system, the redox mediator is a molecular compound. In a second example of the system, optionally including the first example, the redox mediator is 2,5-di-tert-butyl-1,4-dimethoxybenzene (DDB), and the cathode active material is lithium iron phosphate. In a third example of the system, optionally including one or both of the first and second examples, the cathode pre-lithiation material is one or more of Li₂O₂, Li₂CO₃, and Li₂C₂O₄. In a fourth example of the system, optionally including one or more or each of the first through third examples, cathode active material is interspersed with the cathode pre-lithiation material in a layer of the cathode. In a fifth example of the system, optionally including one or more or each of the first through fourth examples, the cathode active material and cathode pre-lithiation material are in adjacent discreet layers of the cathode. In a sixth example of the system, optionally including one or more or each of the first through fifth examples, the electrolyte further includes lithium salts and carbonate solvent. In a seventh example of the system, optionally including one or more or each of the first through sixth examples, the redox mediator is included in the electrolyte at a concentration in a range of 5 mM up to 50 mM.

The disclosure also provides support for a method of pre-lithiating a lithium ion battery, comprising: constructing the lithium ion battery, the lithium ion battery comprising a cathode including a cathode pre-lithiation material and cathode active material, an anode, and an electrolyte, the electrolyte including a redox mediator, pre-charging the lithium ion battery to a charging cutoff voltage at a pre-charging rate to extract lithium from the cathode, and pre-lithiating the lithium ion battery by charging the lithium ion battery above a minimum pre-lithiation rate based on a concentration of the redox mediator. In a first example of the method, the minimum pre-lithiation rate is further based on an interelectrode spacing of the lithium ion battery. In a second example of the method, optionally including the first example, the method further comprises: pre-lithiating to a pre-lithiation cutoff voltage, wherein the pre-lithiation cutoff voltage is higher than the charging cutoff voltage. In a third example of the method, optionally including one or both of the first and second examples, the pre-lithiation cutoff voltage is at or below 4.5V. In a fourth example of the method, optionally including one or more or each of the first through third examples, the method further comprises: pre-lithiating for a threshold length of time. In a fifth example of the method, optionally including one or more or each of the first through fourth examples, pre-lithiating the lithium ion battery includes oxidizing the redox mediator and oxidizing the cathode pre-lithiation material using the oxidized redox mediator as an oxidizing agent. In a sixth example of the method, optionally including one or more or each of the first through fifth examples, the method further comprises: operating the lithium ion battery, wherein operating the lithium ion battery does not oxidize the redox mediator.

The disclosure also provides support for a method for pre-lithiating a lithium ion battery, comprising: preparing a cathode and anode, the cathode including cathode active material and cathode pre-lithiation material, preparing an electrolyte including lithium salt, redox mediator, and organic carbonate solvent, wherein a redox potential of the redox mediator is higher than a redox potential of the cathode pre-lithiation material and the redox potential of the redox mediator is outside an operating voltage window of the cathode active material, constructing the lithium ion battery with the cathode, the anode, and the electrolyte, pre-lithiating the lithium ion battery by applying current to a pre-lithiation cutoff voltage at or above a minimum pre-lithiation rate to oxidize the redox mediator and facilitate decomposition of the cathode pre-lithiation material to provide lithium ions. In a first example of the method, the minimum pre-lithiation rate is based on an interelectrode distance of the lithium ion battery and a concentration of the redox mediator in the electrolyte. In a second example of the method, optionally including the first example, the redox mediator is a molecular compound. In a third example of the method, optionally including one or both of the first and second examples, the method further comprises: charging to a charging cutoff voltage at a charging rate before pre-lithiating. In a fourth example of the method, optionally including one or more or each of the first through third examples, the method further comprises: preparing the cathode by casting a slurry including the cathode active material and cathode pre-lithiation material or by casting a first slurry including the cathode active material and then casting a second slurry including the cathode pre-lithiation material.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An uncharged lithium ion battery, comprising:
a cathode including cathode active material and cathode pre-lithiation material, wherein the cathode has not been charged; and
an electrolyte including a redox mediator, wherein the electrolyte is in fluid contact with the cathode and wherein a redox potential of the redox mediator is higher than a redox potential of the cathode pre-lithiation material and the redox potential of the redox mediator is outside an operating voltage window of the cathode active material.

2. The uncharged lithium ion battery of claim 1, wherein the redox mediator is a molecular compound.

3. The uncharged lithium ion battery of claim 1, wherein the redox mediator is 2,5-di-tert-butyl-1,4-dimethoxybenzene (DDB) and the cathode active material is lithium iron phosphate.

4. The uncharged lithium ion battery of claim 1, wherein the cathode pre-lithiation material is one or more of Li₂O₂, Li₂CO₃, and Li₂C₂O₄.

5. The uncharged lithium ion battery of claim 1, wherein cathode active material is interspersed with the cathode pre-lithiation material in a layer of the cathode.

6. The uncharged lithium ion battery of claim 1, wherein the cathode active material and cathode pre-lithiation material are in adjacent discreet layers of the cathode.

7. The uncharged lithium ion battery of claim 1, wherein the electrolyte further includes lithium salts and carbonate solvent.

8. The uncharged lithium ion battery of claim 1, wherein the redox mediator is included in the electrolyte at a concentration in a range of 5 mM up to 50 mM.

9. A method of pre-lithiating a lithium ion battery, comprising:
constructing the lithium ion battery, the lithium ion battery comprising a cathode including a cathode pre-lithiation material and cathode active material, an anode, and an electrolyte, the electrolyte including a redox mediator;
pre-charging the lithium ion battery to a charging cutoff voltage at a pre-charging rate to extract lithium from the cathode; and
pre-lithiating the lithium ion battery by charging the lithium ion battery above a minimum pre-lithiation rate based on a concentration of the redox mediator in the electrolyte.

10. The method of claim 9, wherein the minimum pre-lithiation rate is further based on an interelectrode spacing of the lithium ion battery.

11. The method of claim 9, wherein pre-lithiating includes charging to a pre-lithiation cutoff voltage, and the pre-lithiation cutoff voltage is higher than the charging cutoff voltage.

12. The method of claim 11, wherein the pre-lithiation cutoff voltage is at or below 4.5V.

13. The method of claim 9, wherein pre-lithiating includes charging for over a threshold length of time.

14. The method of claim 9, wherein pre-lithiating the lithium ion battery includes oxidizing the redox mediator and oxidizing the cathode pre-lithiation material using the oxidized redox mediator as an oxidizing agent.

15. The method of claim 9, further comprising operating the lithium ion battery, wherein operating the lithium ion battery does not oxidize the redox mediator.

16. A method for pre-lithiating a lithium ion battery, comprising:
constructing the lithium ion battery comprising a cathode, an anode, and an electrolyte, where the cathode includes cathode active material and cathode pre-lithiation material, the electrolyte includes lithium salt, redox mediator, and organic carbonate solvent, and where a redox potential of the redox mediator is higher than a redox potential of the cathode pre-lithiation material and the redox potential of the redox mediator is outside an operating voltage window of the cathode active material; and
pre-lithiating the lithium ion battery by applying current to a pre-lithiation cutoff voltage at or above a minimum pre-lithiation rate to oxidize the redox mediator and facilitate decomposition of the cathode pre-lithiation material to provide lithium ions.

17. The method of claim 16, wherein the minimum pre-lithiation rate is based on an interelectrode distance of the lithium ion battery and a concentration of the redox mediator in the electrolyte.

18. The method of claim 16, wherein the redox mediator is a molecular compound.

19. The method of claim 16, further comprising charging to a charging cutoff voltage at a pre-charging rate before pre-lithiating.

20. The method of claim 16, further comprising preparing the cathode by casting a slurry including the cathode active material and the cathode pre-lithiation material, or by casting a first slurry including the cathode active material and casting a second slurry including the cathode pre-lithiation material.
